(19) United States
(12) Patent Application Publication
(10) Pub. No.: US 2025/0193606 A1
(43) Pub. Date: Jun. 12, 2025

(54) RUBBER VOICE DIAPHRAGM, ACOUSTIC GENERATOR AND APPLICATION THEREOF

(71) Applicant: AAC Microtech (Changzhou) Co., Ltd., Changzhou (CN)

(72) Inventors: Yuanwei Su, Changzhou (CN); Hongyuan Wang, Changzhou (CN); Hezhi Wang, Changzhou (CN); Chao Wang, Changzhou (CN)

(21) Appl. No.: 18/669,569

(22) Filed: May 21, 2024

Related U.S. Application Data
(63) Continuation of application No. PCT/CN2023/136629, filed on Dec. 6, 2023.

(51) Int. Cl. H04R 7/02; C08K 3/04; C08K 3/22; C08K 5/09; C08K 5/14; C08K 5/18; C08K 5/3492

(52) U.S. Cl. CPC H04R 7/02; C08K 3/04; C08K 3/22; C08K 5/09; C08K 5/14; C08K 5/18; C08K 5/34924; C08K 2003/2296; H04R 2207/00

(57) ABSTRACT

A rubber voice diaphragm including distortion improving agent with mass percentage of 0.3% to 60%. The distortion improving agent is macromolecule polymer with hyperbranched structure, and has specific chemical crosslinking points with mass percentage of 0.01% to 15%. Branches of the macromolecule polymer with hyperbranched structure are long or short chain structures prepared by active polymerization. Each distortion improving agent molecule includes at least three long or short chain structures, and number-average molecular weight of the long chain structure or the short chain structure is 200 to 50000. The specific chemical crosslinking points are distributed at the outermost end of the hyperbranched structure, and the adjacent specific chemical crosslinking points are separated by at least six carbon atoms. The damping peak position, height, and width of the rubber voice diaphragm are controllable, thereby improving mechanical properties and ensuring stable performance and excellent processing performance of the rubber voice diaphragm.

### TECHNICAL FIELD

The present disclosure relates to the field of new materials and, in particular, to a rubber voice diaphragm, an acoustic generator and an application thereof.

### BACKGROUND

Rubber voice diaphragms are favored in the field of high-end acoustic generator due to their unique physical properties. More and more attention has been paid to the application of distortion improving agent in rubber voice diaphragms to improve the performance of rubber voice diaphragms and reduce the total harmonic distortion (THD) of acoustic generators. Although micromolecule distortion improving agents have a significant effect on improving distortion, they may cause loss of partial mechanical properties of the rubber voice diaphragms. Macromolecule distortion improving agents can improve the distortion, and reduce the loss of mechanical properties of the rubber voice diaphragms. However, macromolecule distortion improving agents are generally linear polymers, and due to segment shielding and steric hindrance effect, the crosslinking points are difficult to fully and effectively react, resulting in unstable performance of the rubber voice diaphragms.

Therefore, there is an urgent need in this field for a rubber voice diaphragm that can improve distortion, minimize the loss of mechanical properties of the rubber voice diaphragms, and ensure stable performance of the rubber voice diaphragms.

### SUMMARY

In order to solve the above technical problems, on the one hand, the present disclosure provides a rubber voice diaphragm including a distortion improving agent with a mass percentage of 0.3% to 60%. The distortion improving agent is a macromolecule polymer with hyperbranched structure, the distortion improving agent has specific chemical crosslinking points with a mass percentage of 0.01% to 15%, branches of the macromolecule polymer with a hyperbranched structure are long chain structures or short chain structures, each distortion improving agent molecule comprises at least three long chain structures or short chain structures, a number-average molecular weight of the long chain structure or the short chain structure is 200 to 50000, the long chain structures or the short chain structures are prepared by active polymerization, the specific chemical crosslinking points are distributed at an outermost end of the hyperbranched structure, and adjacent specific chemical crosslinking points are separated by at least six carbon atoms.

As an improvement, a number-average molecular weight of the macromolecule polymer with hyperbranched structure is 1000 to 1000000.

As an improvement, the active polymerization includes active radical polymerization, anionic polymerization, cationic polymerization or coordination polymerization.

As an improvement, the specific chemical crosslinking points include at least one of double bond, triple bond, isocyanate group, silicon hydrogen bond, silicon chloride bond, azide group, epoxy group, nitrile group, silicon oxygen bond, carboxyl group, hydroxyl group, amide group, amino group, acyl chloride bond, anhydrides group.

As an improvement, the rubber voice diaphragm further includes a main rubber, a reinforcing filler, a vulcanizing agent, a vulcanizing additive, an anti-aging agent, a mold release agent and a plasticizer

The rubber voice diaphragm according to the present disclosure includes a specific distortion improving agent. The distortion improving agent is a macromolecule polymer with hyperbranched structure, and branches thereof are long chain structures or short chain structures prepared by active polymerization. Each distortion improving agent molecule includes at least three long chain structures or short chain structures. The specific chemical crosslinking points are distributed at the outermost end of the hyperbranched structure, and the adjacent specific chemical crosslinking points are separated by at least six carbon atoms. By using active polymerization, the structure of the branches is controllable, such that the damping peak position, height, and width of the rubber voice diaphragm are also controllable. The specific chemical crosslinking points are located at the outermost end of the hyperbranched structure, which can effectively avoid molecular chain entanglement or incomplete reaction caused by steric hindrance effect, in such a manner to allow the crosslinking points to effectively and fully react and play a role in concentrating the crosslinking points, thereby significantly improving mechanical properties of the rubber voice diaphragm and ensuring stable performance of the rubber voice diaphragm. In addition, the hyperbranched structure gives the rubber voice diaphragm excellent processing performance.

On the other hand, the present disclosure further provides an acoustic generator, which includes the rubber voice diaphragm as described above. In a specific low-frequency range, the THD of the acoustic generator is significantly reduced, the sound quality is improved, and frequency response for FO are almost unaffected. The acoustic generator can be applied to fields such as phone, headphone, smartwatch, tablet, laptop, desktop, speaker, television, and car.

### BRIEF DESCRIPTION OF DRAWINGS

FIG. 1 is a structural schematic diagram of a molecular of a distortion improving agent according to the present disclosure; and

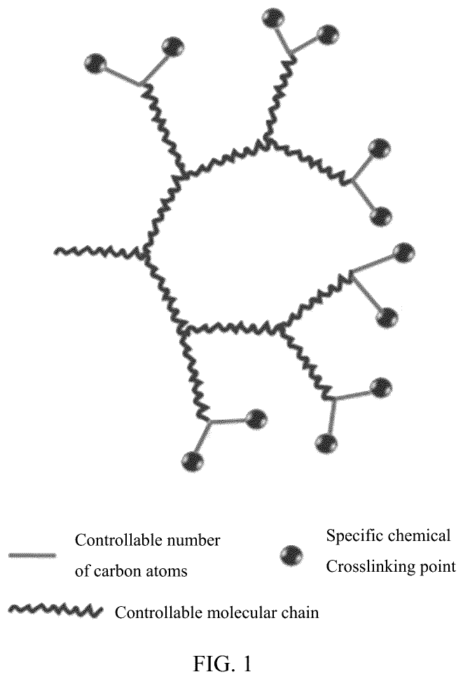

FIG. 2 shows THD curves of speakers made of existing rubber voice diaphragm and of the rubber voice diaphragm according to the present disclosure, respectively.

### DESCRIPTION OF EMBODIMENTS

The present disclosure is described below in conjunction with the drawings and embodiments.

Synthesis of 2-bromosuccinic acid dipropargyl alcohol ester (BPBS):

By mass, 100 parts of 2-bromosuccinic acid, 290 parts of propargyl alcohol, and 5 parts of p-Toluenesulfonic acid are added to a reactor, and 1000 parts of dry toluene are added to the reactor. When the dissolution is complete, the above substances react in an oil bath at 90° C. for 36 hours. When the reaction is complete, the oil bath is cooled to room temperature. Depressurization and rotary distillation are performed at 60° C. to remove the toluene, 1500 to 2000 parts of dichloromethane are added to redissolve the product subjected to rotary distillation. The obtained solution is washed four times with NaOH solution (3% wt to 5% wt), then washed four times with water, and dried with excess anhydrous MgSO₄ added. Afterwards, the solution is filtered to collect the filtrate. Depressurization and rotary distillation are performed at 35° C. to remove the dichloromethane, and the product passes through a 60 cm silica gel column (an eluent is ethyl acetate: dichloromethane=3:1). After obtaining a product solution, rotary distillation is performed at 50° C. to remove the eluent, and the product solution is dried, at room temperature, in a vacuum drying oven for 48 hours to obtain the 2-bromosuccinic acid dipropargyl alcohol ester (BPBS).

### Synthesis of Linear Styrene (Br-Ps)

By mass, 1 part of BPBS, 2 parts of bipyridine, 15 parts of styrene, and 0.5 parts of CuBr are added to the reactor successively. Nitrogen is introduced for 1 hour, so that the above substances react at 110° C. for 2 hours. Afterwards, the reactor is rapidly cooled to room temperature and air is introduced. Post processing: the polymer solution is diluted with tetrahydrofuran (THF), and passes through a 30 cm neutral alumina column to remove copper. The obtained polymer solution is slowly dropped into methanol for precipitation, and the resulting solution is frozen in a refrigerator for 1 hour. The solution is filtered to obtain a solid product, which is dissolved in THF and precipitated again with methanol, and the resulting solution is stirred and frozen in the refrigerator for 1 hour. After the solution is filtered, it is dried, at room temperature, in the vacuum drying oven for 48 hours to obtain the linear styrene (Br-Ps).

### Embodiment 1

By mass, 100 parts of linear styrene (Br-Ps), 30 parts of acrylic acid-2-ethylhexyl, 2 parts of bipyridine, and 0.5 parts of CuBr were taken. Nitrogen was introduced for 1 hour to allow the above substances to react at 110° C. for 2 hours. Afterwards, the reactor was rapidly cooled to room temperature and air was is introduced. Post processing: the polymer solution was diluted with THF and passed through a 30 cm neutral alumina column to remove copper. The obtained polymer solution was slowly dropped into methanol for precipitation, and the resulting solution was frozen in a refrigerator for 1 hour. The solution was filtered to obtain a solid product, which was dissolved in THF and precipitated again with methanol, and the resulting solution was stirred and frozen in the refrigerator for 1 hour. After the solution was filtered, it was dried, at room temperature, in the vacuum drying oven for 48 hours to obtain Br-PS-P2HEA (copolymer of styrene containing bromine groups and acrylic acid 2-ethylhexyl).

By mass, 1 part of Br-PS-P2HEA, 0.3 parts of sodium azide, and 3 parts of dry N, N-dimethyl formamide (DMF) were stirred magnetically and fully dissolved so that the above substances react at 40° C. for 24 hours. When the reaction was complete, the polymer solution was diluted with THF and passed through the 30 cm neutral alumina column to remove metal salts (sodium azide). Afterwards, the solution was precipitated with methanol, and was redissolved and precipitated again. The solution was dried, at room temperature, in the vacuum drying oven for 48 hours to obtain N3-PS-P2HEA (copolymer of styrene containing azide groups and acrylic acid 2-ethylhexyl).

By mass, 1 part of N3-PS-P2HEA, 1 part of CuBr, 1 part of Pentamethylenetriamine, and moderate amount of dry DMF were stirred magnetically and fully dissolved. Nitrogen was introduced for 1 hour, so that the above substances react at 60° C. for 24 hours. The reactor was rapidly cooled to room temperature and air was introduced. Post processing: the polymer solution was diluted with THF and passed through a 30 cm neutral alumina column to remove copper. Afterwards, the polymer solution was precipitated with methanol and filtered, and dissolution and precipitation were repeated twice. The solution was dried, at room temperature, in the vacuum drying oven for 48 hours to obtain the desired distortion improving agent 1.

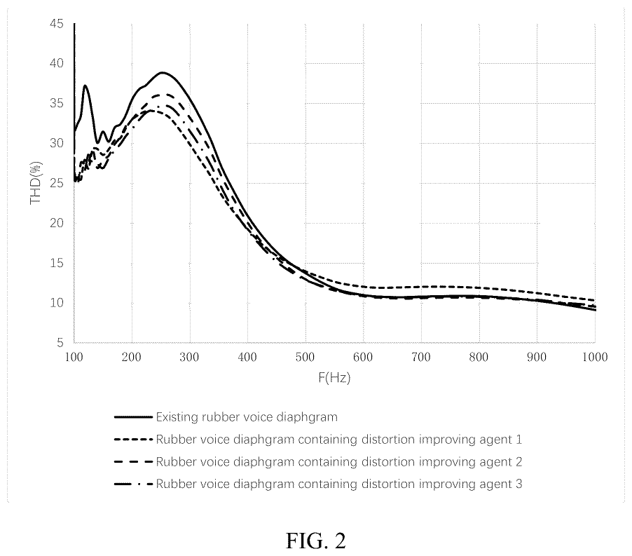

Taking hydrogenated nitrile rubber (HNBR) as an example, the rubber compound containing the distortion improving agent 1 was obtained according to Table 1. The rubber compound was pressed or coated into a thin sheet with a thickness about 100 microns using a rubber calendaring machine, a flat vulcanizing machine, or a coating machine. The thin sheet was hot pressed for 10 minutes using a voice diaphragm pressing machine under the conditions of 200° C. and 0.2 MPa to obtain the rubber voice diaphragm. The voice diaphragm was assembled into a speaker and its distortion (THD) performance was tested. The results are shown in FIG. 2.

### Embodiment 2

By mass, 100 parts of linear styrene (Br-Ps), 35 parts of acrylic acid-2-ethylhexyl, 2 parts of bipyridine, and 0.5 parts of CuBr were taken. Nitrogen was introduced for 1 hour, so that the above substances react at 110° C. for 2 hours. Afterwards, the reactor was rapidly cooled to room temperature and air was is introduced. Post processing: the polymer solution was diluted with THF and passed through a 30 cm neutral alumina column to remove copper. The obtained polymer solution was slowly dropped into methanol for precipitation, and the resulting solution was frozen in a refrigerator for 1 hour. The solution was filtered to obtain a solid product, which was dissolved in THF and precipitated again with methanol, and the resulting solution was stirred and frozen in the refrigerator for 1 hour. After the solution was filtered, it was dried, at room temperature, in the vacuum drying oven for 48 hours to obtain Br-PS-P2HEA.

By mass, 1 part of Br-PS-P2HEA, 0.3 parts of sodium azide, and 3 parts of dry N, N-dimethyl formamide (DMF) were stirred magnetically and fully dissolved, so that the above substances react at 40° C. for 24 hours. When the reaction was complete, the polymer solution was diluted with THF and passed through the 30 cm neutral alumina column to remove metal salts (sodium azide). Afterwards, the solution was precipitated with methanol, and was redissolved and precipitated again. The solution was dried, at room temperature, in the vacuum drying oven for 48 hours to obtain N3-PS-P2HEA.

By mass, 1 part of N3-PS-P2HEA, 1 part of CuBr, 1 part of Pentamethylenetriamine, and moderate amount of dry DMF were stirred magnetically and fully dissolved. Nitrogen was introduced for 1 hour, so that the above substances react at 60° C. for 24 hours. The reactor was rapidly cooled to room temperature and air was introduced. Post processing: the polymer solution was diluted with THF and passed through a 30 cm neutral alumina column to remove copper. Afterwards, the polymer solution was precipitated with methanol and filtered, and dissolution and precipitation were repeated twice. The solution was dried, at room temperature, in the vacuum drying oven for 48 hours to obtain the desired distortion improving agent 2.

Taking hydrogenated nitrile rubber (HNBR) as an example, the rubber compound containing the distortion improving agent 2 was obtained according to Table 1. The rubber compound was pressed or coated into a thin sheet with a thickness about 100 microns using a rubber calendaring machine, a flat vulcanizing machine, or a coating machine. The thin sheet was hot pressed for 10 minutes using a voice diaphragm pressing machine under the conditions of 200° C. and 0.2 MPa to obtain the rubber voice diaphragm. The voice diaphragm was assembled into a speaker and its distortion (THD) performance was tested. The results are shown in FIG. 2.

### Embodiment 3

By mass, 100 parts of linear styrene (Br-Ps), 50 parts of n-Butyl acrylate, 2 parts of bipyridine, and 0.5 parts of CuBr were taken. Nitrogen was introduced for 1 hour, so that the above substances react at 110° C. for 2 hours. Afterwards, the reactor was rapidly cooled to room temperature and air was is introduced. Post processing: the polymer solution was diluted with THF and passed through a 30 cm neutral alumina column to remove copper. The obtained polymer solution was slowly dropped into methanol for precipitation, and the resulting solution was frozen in a refrigerator for 1 hour. The solution was filtered to obtain a solid product, which was dissolved in THF and precipitated again with methanol, and the resulting solution was stirred and frozen in the refrigerator for 1 hour. After the solution was filtered, it was dried, at room temperature, in the vacuum drying oven for 48 hours to obtain Br-PS-PBA (copolymer of styrene containing bromine groups and n-Butyl acrylate).

By mass, 1 part of Br-PS-PBA, 0.3 parts of sodium azide, and 3 parts of dry N, N-dimethyl formamide (DMF) were stirred magnetically and fully dissolved, so that the above substances react at 40° C. for 24 hours. When the reaction was complete, the polymer solution was diluted with THF and passed through the 30 cm neutral alumina column to remove metal salts (sodium azide). Afterwards, the solution was precipitated with methanol, and was dissolved and precipitated again. The solution was dried, at room temperature, in the vacuum drying oven for 48 hours to obtain N3-PS-PBA (copolymer of styrene containing azide groups and n-Butyl acrylate).

By mass, 1 part of N3-PS-PBA, 1 part of CuBr, 1 part of pentamethyldiethylenetriamine (PMDETA), and moderate amount of dry DMF were stirred magnetically and fully dissolved. Nitrogen was introduced for 1 hour, so that the above substances to react at 60° C. for 24 hours. The reactor was rapidly cooled to room temperature and air was introduced. Post processing: the polymer solution was diluted with THF and passed through a 30 cm neutral alumina column to remove copper. Afterwards, the polymer solution was precipitated with methanol and was filtered, and dissolution and precipitation were repeated twice. The solution was dried, at room temperature, in the vacuum drying oven for 48 hours to obtain the desired distortion improving agent 3.

Taking hydrogenated nitrile rubber (HNBR) as an example, the rubber compound containing the distortion improving agent 3 was obtained according to Table 1. The rubber compound was pressed or coated into a thin sheet with a thickness about 100 microns using a rubber calendaring machine, a flat vulcanizing machine, or a coating machine. The thin sheet was hot pressed for 10 minutes using a voice diaphragm pressing machine under the conditions of 200° C. and 0.2 MPa to obtain the rubber voice diaphragm. The voice diaphragm was assembled into a speaker and its distortion (THD) performance was tested. The results are shown in FIG. 2.

In a specific low-frequency range, the THD of the acoustic generator is significantly reduced, the sound quality is improved, and F0 and frequency response are almost unaffected. The acoustic generator can be applied to fields such as phone, headphone, smartwatch, tablet, laptop, desktop, speaker, television, and car.

The acoustic generator including the rubber voice diaphragm according to the present disclosure can be, but is not limited to, the speaker, receiver, and other acoustic generators. Taking the speaker as an example is not intended to limit the application scenarios of the present disclosure.

TABLE 1

| | | Rubber | Rubber | Rubber |
|---|---|---|---|---|
| | | containing | containing | containing |
| | | the distortion | the distortion | the distortion |
| | Existing | improving | improving | improving |
| | rubber | agent 1 | agent 2 | agent 3 |
| Therban 3446 (Trade name, | 100 | 100 | 100 | 100 |
| hydrogenated nitrile rubber, | | | | |
| main rubber) | | | | |
| N-550 (Trade name, carbon | 40 | 40 | 40 | 40 |
| black, reinforcing filler) | | | | |
| 445 (Trade name, 4,4′-double | 1.5 | 1.5 | 1.5 | 1.5 |
| (α,α′-dimethylbenzyl) | | | | |
| diphenylamine, anti-aging | | | | |
| agent) | | | | |
| DX-36 (Low molecular | 10 | 10 | 10 | 10 |
| weight polyester plasticizer) | | | | |
| Zinc oxide (Vulcanizing | 5 | 5 | 5 | 5 |
| additive) | | | | |
| Stearic acid (Plasticizer, mold | 2 | 2 | 2 | 2 |
| release agent) | | | | |
| BIPB (2,4-di-tert- | 3 | 3 | 3 | 3 |
| butylperoxyisopropylbenzene, | | | | |
| vulcanizing agent) | | | | |
| TAIC (Triallyl isocyanurate, | 2 | 2 | 2 | 2 |
| crosslinking agent or | | | | |
| vulcanizing aid) | | | | |
| Distortion improving agent 1 | — | 10 | — | — |
| Distortion improving agent 2 | — | — | 10 | — |
| Distortion improving agent 3 | — | — | — | 10 |

The above provides a detailed description of some specific embodiments according to the present disclosure. Those skilled in the art should understand that the above embodiments are for illustration purposes only and are not intended to limit the scope of the present disclosure.

Those skilled in the art should understand that any modifications, equivalent substitutions, or improvements made to the above embodiments without departing from the spirit and principles of the present disclosure should fall within the protection scope of the present disclosure.

What is claimed is:

1. A rubber voice diaphragm, comprising a distortion improving agent with a mass percentage of 0.3% to 60%, wherein the distortion improving agent is a macromolecule polymer with hyperbranched structure, the distortion improving agent has specific chemical crosslinking points with a mass percentage of 0.01% to 15%, branches of the macromolecule polymer with a hyperbranched structure are long chain structures or short chain structures, each distortion improving agent molecule comprises at least three long chain structures or short chain structures, a number-average molecular weight of the long chain structure or the short chain structure is 200 to 50000, the long chain structures or the short chain structures are prepared by active polymerization, the specific chemical crosslinking points are distributed at an outermost end of the hyperbranched structure, and adjacent specific chemical crosslinking points are separated by at least six carbon atoms.

2. The rubber voice diaphragm as described in claim 1, wherein a number-average molecular weight of the macromolecule polymer with hyperbranched structure is 1000 to 1000000.

3. The rubber voice diaphragm as described in claim 1, wherein the active polymerization comprises active radical polymerization, anionic polymerization, cationic polymerization or coordination polymerization.

4. The rubber voice diaphragm as described in claim 1, wherein the specific chemical crosslinking points comprise at least one of double bond, triple bond, isocyanate group, silicon hydrogen bond, silicon chloride bond, azide group, epoxy group, nitrile group, silicon oxygen bond, carboxyl group, hydroxyl group, amide group, amino group, acyl chloride bond, anhydrides group.

5. The rubber voice diaphragm as described in claim 1, further comprising a main rubber, a reinforcing filler, a vulcanizing agent, a vulcanizing aid, an anti-aging agent, a mold release agent and a plasticizer.

6. An acoustic generator, comprising the rubber voice diaphragm as described in claim 1.

7. A product using the acoustic generator as described in claim 6, wherein the product comprises one of phone, headphone, smartwatch, tablet, laptop, desktop, speaker, television, and car.
